(19) United States
(12) Patent Application Publication
(10) Pub. No.: US 2023/0319225 A1
(43) Pub. Date: Oct. 5, 2023

(54) Automatic Environment Removal For Human Telepresence

(71) Applicant: Nextech AR Solutions Corp., Toronto (CA)

(72) Inventors: Omid Alemi, Vancouver (CA); Tarek Elaydi, Vancouver (CA); Elliott Rothman, Mableton, GA (US); Sebastian Echeverry, Duluth, GA (US); Dawsyn Borland, Toronto (CA)

(21) Appl. No.: 18/192,456

(22) Filed: Mar. 29, 2023

Related U.S. Application Data
(60) Provisional application No. 63/325,266, filed on Mar. 30, 2022.

(51) Int. Cl. H04N 5/272; G06T 7/194; G03H 1/22; G03H 1/00

(52) U.S. Cl. CPC H04N 5/272; G06T 7/194; G03H 1/2294; G03H 1/0005; G06T 2207/10016; G03H 2001/0088

(57) ABSTRACT

A first environment image of a first video environment and a first video record of a subject in the first video environment may be received from a computing device in a fixed position. Based on the first environment image and the first video record, data may be determined. The data may represent the subject separated from one or more features of the first video environment visible in the first video environment. Based on the data, a digital hologram of the subject may be caused to be represented in a second video environment.

### PRIORITY

The disclosure claims the benefit under 35 U.S.C. § 119(e) of U.S. Provisional Patent Application No. 63/325,266 entitled “Automatic Environment Removal For Human Telepresence”, filed on Mar. 30, 2022, which is incorporated herein by reference in its entirety.

### TECHNICAL FIELD

This disclosure pertains to the creation of augmented reality videos by placing video images of human and other subjects into new augmented reality environments without the use of green screens.

### BACKGROUND

U.S. Pat. No. 10,162,308 (Du), Methods and systems for photorealistic human holographic augmented reality communication with interactive control in real-time, Dec. 25, 2018, describes real-time holographic augmented reality image processing comprising: receiving, real-time image data; extracting one or more objects or a scene from the real-time image data based on results from real-time adaptive learning and one or more object/scene extraction parameters; extracting one or more human objects from the real-time image data based on results from real-time adaptive human learning and one or more human extraction parameters; receiving augmented reality (AR) input data; and creating holographic AR image data by projecting, for each image, the extracted object or scene, the extracted human object, where the AR input data is used a multi-layered mechanism based on projection parameters.

The article “Real-Time High-Resolution Background Matting,” by Shanchuan Lin, Andrey Ryabtsev, Soumyadip Sengupta, Brian L. Curless, Steven M. Seitz, Ira Kemelmacher-Shlizerman, of Dec. 14, 2020, as published, e.g., in Proceedings of the IEEE/CVF Conference on Computer Vision and Pattern Recognition (CVPR), 2021, pp. 8762-8771, describes a high-resolution background replacement technique which operates at 30 fps in 4K resolution, and 60 fps for HD on a modern GPU. The technique is based on background matting using object analysis, where an additional frame of the background is captured and used in recovering the alpha matte and the foreground layer.

### BRIEF DESCRIPTION OF THE DRAWINGS

A more detailed understanding may be had from the following description, given by way of example in conjunction with the accompanying drawings.

FIG. 1 illustrates a system for automatic environment removal.

FIG. 2 illustrates initial capture of a first video environment.

FIG. 3 illustrates the capture of a holographic subject (e.g., an actor A) in the context of the first video environment.

FIG. 4 illustrates the steps of processing a video of a holographic subject in the first video environment to produce a digital hologram with the first video environment removed.

FIG. 5 illustrates an example scenario where a creator B captures a new environment and adds a digital hologram into the new environment in a new video.

FIG. 6 illustrates a method for automatic environment removal.

FIG. 7 illustrates a method for automatic environment removal.

FIG. 8 illustrates a computing device.

### DETAILED DESCRIPTION

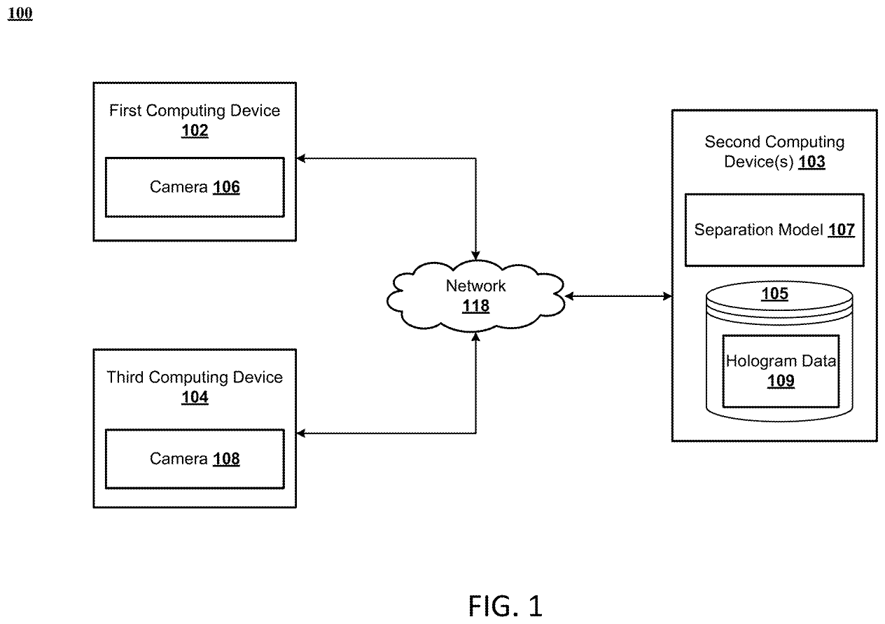

FIG. 1 illustrates a system 100 for automatic environment removal. The system 100 comprises a first computing device 102, at least one second computing device 103, and a third computing device 104. The first computing device 102, the second computing device(s) 103, and the third computing device 104 may be in communication via a network 118. The network 118 may comprise one or more public networks (e.g., the Internet) and/or one or more private networks. A private network may include a wireless local area network (WLAN), a local area network (LAN), a wide area network (WAN), a cellular network, or an intranet. The network 118 may comprise wired network(s) and/or wireless network(s).

The first computing device 102 may be configured to capture (e.g., record) a first environment image (e.g., digital image) of a first video environment (e.g., an original environment). The first computing device 102 may comprise a camera 106. The camera 106 may capture the first environment image of the first video environment. The first video environment may comprise a field of view of the camera 106. For example, the first video environment may comprise a room, as seen by the camera 106 of the computing device 102. To capture the first environment image of the first video environment, a user of the first computing device 102 may capture the first environment image in a room or in their home where no one is standing. Herein, the term “environment” refers to a physical or virtual space in which holographic subjects may be captured and/or presented. An “environment image” may be a 2D background, for example, or a 3D model of an environment.

The first computing device 102 may be configured to capture the first environment image of the first video environment in a fixed location. For example, the first computing device 102 may be attached to a tripod (e.g., or other support device and/or support structure supporting the computing device 102). The first computing device 102 may configured to capture the first environment image of the first video environment when attached to the tripod. The first environment image may comprise a photograph (e.g., optical photograph) or a video. The first environment image may comprise a combination of data from multiple sensors. The first environment image may comprise a depth image or a thermal image, or some combination of photo, video, depth image, and thermal image. The first environment image may be stereographic. Capturing the first video environment in a variety of ways, e.g., at different angles and/or in different spectra, may help to distinguish objects existing in first video environment. A user of the first computing device 102 may be prompted to begin capturing the first environment image. The user of the first computing device 102 may be prompted to end capturing the first environment image.

The computing device 102 may be any of a variety of different types of devices, including for example, a smartphone (e.g., smart cell phone), a tablet computer, a laptop computer, a notebook computer, a personal computer, a television, a smart television, other consumer electronics, and the like.

A holographic subject may be added into the first video environment. As described above, the first video environment may comprise a field of view of the camera 106. The holographic subject may be added into the first video environment by positioning the holographic subject in the field of view of the camera 106. The holographic subject may not have been present when the first environment image of the first video environment was captured. The holographic subject may comprise one or more of a person, e.g., an actor, dancer, singer, speaker, etc., and/or a puppet or animatronic device. The holographic subject may be anything introduced into the scene which was not present the first environment image of the first video environment was captured. For example, the holographic subject may comprise a user associated with the computing device 102. The holographic subject may include more than one person and/or any props that the people carry, for instance. Herein, the term “holographic subject” refers to a real-world object which is desired to be displayed in a video environment that is different from the video environment in which the real-world object is originally observed and recorded.

The first computing device 102 may be configured to capture a first video record of the holographic subject in the first video environment. For example, the first computing device 102 may be configured to capture a first video record of the holographic subject moving in the first video environment. One or more video processing effects may be configured to be applied to the first video record. The one or more video processing effects may be configured to be applied to the first video record based on inputs received from a user of the first computing device 102. A user of the first computing device 102 may be prompted to begin capturing the first video record. A user of the first computing device 102 may be prompted to end capturing the first video record.

The first computing device 102 may be configured to send the first environment image and the first video record to the second computing device(s) 103. The second computing device(s) 103 may be located remote to the first computing device 102. The second computing device(s) 103 may receive the first environment image and the first video record from the first computing device 102. The second computing device(s) 103 may be configured to quickly and accurately separate holographic subjects in the foreground of a video from a complex first environment to create a digital hologram that may then be integrated with a second video environment to form a new video. For example, the second computing device(s) 103 may use the first environment image to identify objects in the environment. With foreknowledge of the environment, the second computing device(s) 103 may then determine the exact contours of the holographic subject moving in the environment. The second computing device(s) 103 may produce (e.g., generate) a digital hologram of the holographic subject (e.g., a video record of the person just filmed with the environment removed). Herein “digital hologram” refers to a digital representation of such a real-world object. A digital hologram may be 2D or 3D, depending on capture technology, analysis tools, and/or desired storage format.

The second computing device(s) 103 may comprise a separation model 107. The separation model 107 may be configured to separate a digital hologram of the holographic subject from any element of the first video environment visible in the first video record. The separation model 107 may be configured to separate a digital hologram of the holographic subject from any element of the first video environment visible in the first video record using object detection. The object detection may be performed using a machine learning model and/or deep artificial neural network analysis of a video. Object detection, which may encompass artificial intelligence training of a system to identify real-world structures visible in video images, may be used in place of, or in addition to, chromakey technology for environment subtraction. Via object analysis, for example, fine details of human hair, may be accurately captured and preserved in the digital hologram after environment removal. Object analysis thereby enables video capture of raw footage of a holographic subject set against a complex environment, and removal of the environment while preserving the subject's details in a digital hologram for display in different video context. Data and/or metadata associated with the digital hologram may be stored as hologram data 109 in a database 105.

The digital hologram may be integrated with (e.g., incorporated into) a second video environment to form a new video for display. For example, the digital hologram may be superimposable on a second video environment (e.g., new video environment) to create a second video record. For example, the digital hologram may be superimposed over a new static or moving 2D background video image or added to a 3D environment. The digital hologram may be positioned within the second video environment based on one or more inputs received from a user of the first computing device 102.

The second video environment may comprise any physical space and/or virtual environment. For example, the second video environment may comprise a pre-recorded, computer generated, and/or computer enhanced environment, or a combination of many environments. The second video environment may be captured by the first computing device 102. The second video environment may be captured by the first computing device 102 while displaying a preview of the digital hologram superimposed on the second video environment. Alternatively, the second video environment may be captured by a different computing device, such as by a camera 108 of the third computing device 104. All of this may be facilitated by using object detection methods similar to those described by Lin, et al., without requiring the user to use a “green screen” to hide the environment in which the person is filmed.

One or more video processing effects may be configured to be applied to the second video record. The one or more video processing effects may be configured to be applied to the second video record based on one or more inputs received from a user of the first computing device 102. Applying the one or more video processing effects to the second video record may comprise repositioning the digital hologram within the second video environment. An object analysis of the digital hologram may be performed. The object analysis may be performed to identify portions of a body of the digital hologram. The one or more video processing effects may comprise an effect triggered by a gesture made by the digital hologram. The one or more video processing effects comprise an effect triggered by a position of a portion of the digital hologram relative to the second video environment.

The second video record may be livestreamed. The second video record may be livestreamed while the first video record is captured. The second video record may be livestreamed by the first computing device 102 and/or by the second computing device(s) 103. In this way users may create pre-recorded and live-stream augmented reality human telepresence renderings of themselves with their mobile phone, in real-time. For example, if needed certain portions of the video processing may be offloaded to cloud computational resources on the Internet. The resulting final video products can be stored and/or live streamed from the cell phone or from a cloud computing resource.

One example of FIG. 1 is filming a person on a cell phone with a conventional built-in video camera. As another example, filming may be performed using a laptop, desktop, and/or server computing devices. Stereoscopic, depth image, thermal, and other image sensors may be used with convention cameras in any combination, for example, to help create more accurate 2D holograms, or used to create 3D holograms. 3D holograms may also be created, at least in part, by using inverse rendering, e.g., by inferring three-dimensional structures of objects captured in one or more 2D images based on shading and differences in appearance from different points of view.

The combination of use the object analysis and dividing video processing between local and cloud devices permits ordinary consumers to generate video content using undistorted holograms while filming in their preferred environments without the use of green screens. This facilitates the production of high-quality User Generated Content (UGC) for personal and social use. For example, artists, public figures, brand ambassadors, and social media influencers who are looking to connect with their communities through augmented reality, extended reality, and/or mixed reality human telepresence, in real time may be able to access such technology through equipment they already possess. In the age of remote work, the applications are innumerable. Other examples include casting tapes, auditions, artistic performances, keynote speeches, job interviews, online dating, customer support, personal messages, product demos, higher education lectures, etc.

Holograms may be created not just for people, but also for telepresence of animals, puppets, and/or animatronic devices, and any combination thereof. Thus, a digital hologram may be of an individual, a portion of an individual, or a group of individuals, for example.

Automatic environment removal may be of most value for user looking for a new, low-touch way to engage with audiences, as it will enable augmented reality, extended reality, and/or mixed reality human telepresence without the need for chromakey technology and the use of a green screen. Moreover, livestream human telepresence creates more opportunities for users to create UGC that communicates to audiences in real time. As all of this may be accomplished by through a mobile device, the ubiquity and high-quality film recordings of smartphones positions makes the techniques described herein a valuable feature for potential users.

Commercial livestreaming applications are also enabled by the techniques described herein. Livestream human telepresence using holograms may be used to engage with audiences in a new medium, through live broadcast. In addition to live streaming, the techniques described herein may apply to environment removal for prerecorded human telepresence. This enables users to film their footage and display it in augmented reality, rather than recording a traditional video to deliver messaging, for example. Users will be able to record and rerecord their footage before publishing it and making it publicly available to their audience.

As described above, an original environment may be filmed (e.g., captured). Then a holographic subject may be captured in that environment. Portions of the original environment which are visible when the holographic subject is filmed may be subtracted to produce a field-less image of the holographic subject (e.g., a digital hologram). The digital hologram may then be superimposed on any desired final environment.

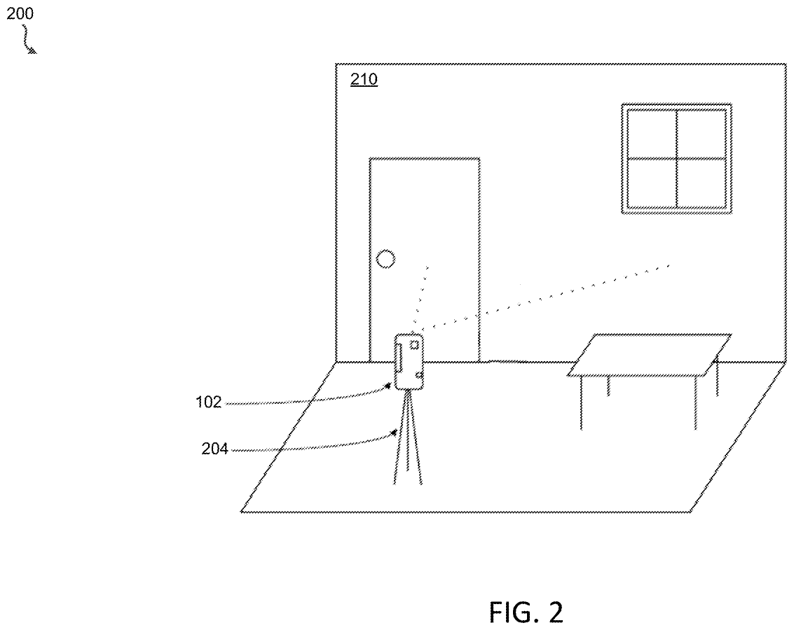

FIG. 2 illustrates a scenario 200 in which an original environment is captured as a digital image by the computing device 102. The environment context 210 is a room having a door, a window, and a table. The original environment is the room as seen by one or more cameras of the computing device 102. The digital image may be an optical photograph or a video, for example. A digital image may also be a depth image or a thermal image, or some combination of photo, video, depth image, and thermal image. The digital image may also be stereographic, for instance. Recording the original environment in a variety ways, e.g., at different angles and in different spectra, may help to distinguish objects existing in the original environment. The computing device 102 is depicted as a smart cell phone and is shown supported on a tripod 204. A tripod may be useful for fixing the frame of reference and/or field of view for future photography of a holographic subject in the same context. The field of view of the computing device 102 is suggested by the dotted lines, and the back of the computing device 102 is shown giving a preview of the resulting original environment image. It should be understood that other computing devices may be used instead of a smart cell phone. Other support structures may also be used instead of a tripod. The examples shown are only for purposes of illustration and not intended to be limiting.

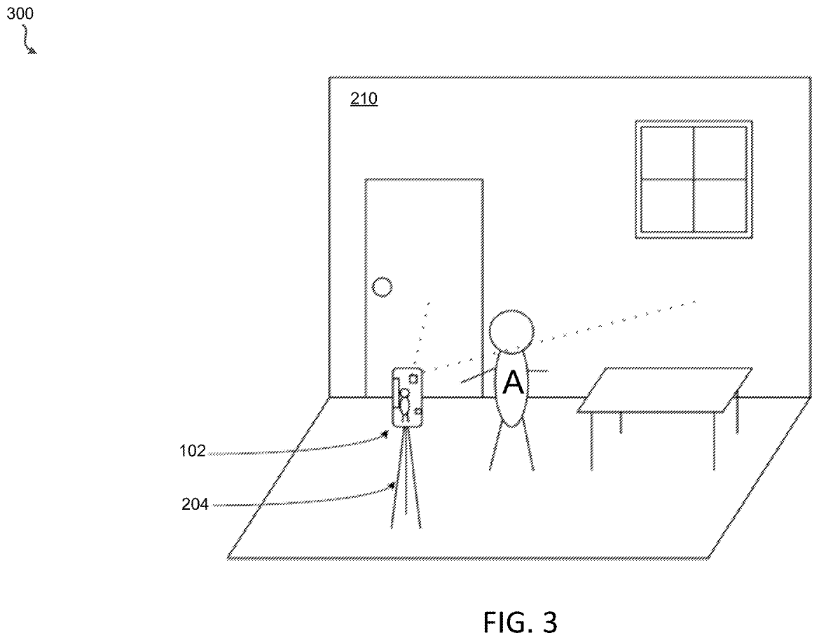

A holographic subject may be added into the original environment. The holographic subject may not have been present when the digital image of the original environment was captured. FIG. 3 illustrates a scenario 300 in which a holographic subject A is added to the scene of FIG. 2. The holographic subject A may be a person, e.g., an actor, dancer, singer, speaker, etc., and/or a puppet or animatronic device. The holographic subject A may be anything introduced into the scene which is not present when the digital image of original environment was created. The holographic subject A may include more than one person and include any props the people carry, for instance.

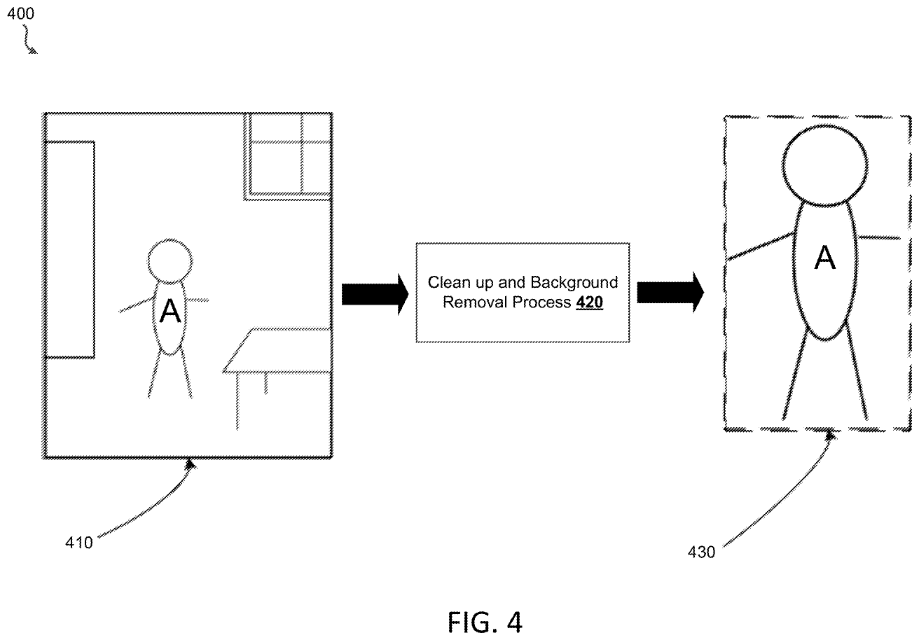

The holographic subject A may be separated from the original environment to create a digital hologram that may then be integrated with a second video environment to form a new video. FIG. 4 illustrates the environment subtract process 400. Image 410 includes the digital hologram subject A in the context of the original environment. At step 420, the image 410 may be processed in a number of ways. First, foreknowledge of the original environment, obtained prior to the introduction of the digital hologram subject into the field of view, is applied to remove any element of the original environment that are visible in image 410. The result is a digital hologram 430 of hologram subject A in isolation with no environment per se. In addition, image 410 may be processed to improve video quality or add visual effects, e.g., through blurring, de-blurring, overlaying multiple exposures, etc. Such additional image processing may occur before and/or after environment removal.

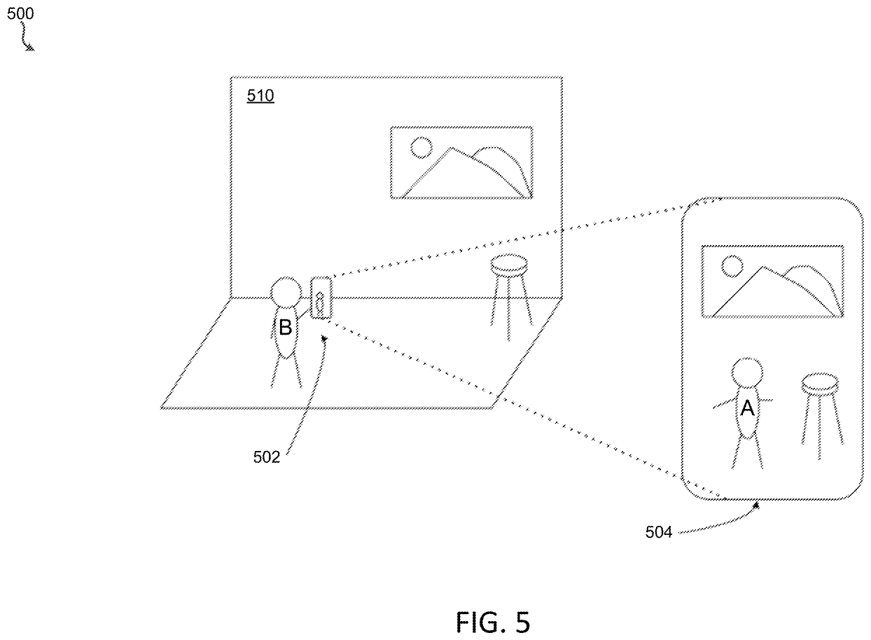

The digital hologram 430 of hologram subject A may be integrated with (e.g., incorporated into) a second video environment to form a new video for display. FIG. 5 illustrates a scenario 500 in which a creator B generates a new image 504 in which the digital hologram 430 of hologram subject A is superimposed in a new environment 510. The new environment 510 may be captured in a set comprising a stool and landscape imagery. In this example, the creator B is using a mobile device 502 (e.g., third computing device 104) to record the new environment 510. The mobile device 502 may not be fixed on a tripod, so that creator B can vary the new environment 510, e.g., by scanning the scene and/or moving the perspective in response to and/or in sync with a preview of the digital hologram 430 displayed on the mobile device. The new environment 510 may comprise any physical space or virtual environment 510. For example, the creator B may use a pre-recorded, computer generated, and or computer enhanced environment as the new environment 510, or a combination of many environments.

Creator B may invoke any number of video effects on the digital hologram 430, the new environment 510, and/or interactions between the digital hologram 430 and the new environment 510. For example, environments may be generated or enhanced based on the digital hologram 430. Video effects may be used to generate repeated, mirrored, and/or kaleidoscopic scenes based on the digital hologram 430 and/or movement of the digital hologram 430. Actions of the digital hologram 430 may trigger video effects and/or changes in the environment. For example, object analysis may be applied to the digital hologram 430 to detect parts of the digital hologram 430 and gestures by the digital hologram 430. For example, in the case of a human holographic subject, limbs, hands, feet, the head, and/or other parts of the body may be identified, and combinations of relative movements may be interpreted automatically and/or with assistance by creator B to be associated with certain triggers for changes in the environment or video effects, or changes in the position of the digital hologram 430 relative to the new environment 510. Additionally, or alternatively, chromakey technology may be used to identify portions and/or gestures of the digital hologram 430.

For example, walking may be detected, and the digital hologram 430 may be accordingly moved within the new environment 510, as if the person filmed were really in the new environment 510. Similarly, real and/or pantomime motions may be detected and used to control position of the digital hologram 430 within frame. For example, the digital hologram 430 may appear to swim or fly across the new environment 510 based on the motion of their arms and legs. Similarly, certain dance moves may be identified to trigger lighting effects, or a gesture of knocking may trigger a scene change to an environment showing the opening of a door. Similarly, motion and/or position of the digital hologram 430 may be used to trigger visual effects simulating interaction between the digital hologram 430 and objects in the new environment 510. For example, when the hand of the digital hologram 430 intersects with the edge of a balloon in the environment, the balloon may be seen to pop. It will be appreciated that the techniques described herein may be applied using a wide variety of camera, computing, and network technologies.

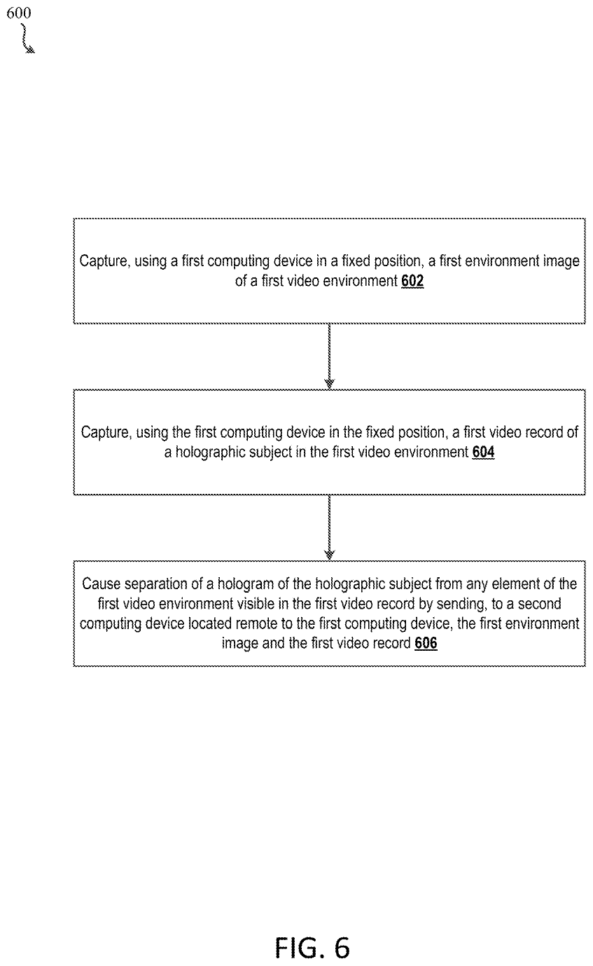

FIG. 6 illustrates an exemplary method 600 for method for automatic environment removal. The method 600 may be performed, for example, by the first computing device 102 of FIG. 1.

At 602, a first environment image may be captured. The first environment image may be captured using a first computing device. The first environment image may comprise an image of a first video environment. The first computing device may comprise a camera. The camera may capture the first environment image of the first video environment. The first video environment may comprise a field of view of the camera. To capture the first environment image of the first video environment, a user of the first computing device may capture the first environment image in a room or in their home where no one is standing.

The first computing device may be configured to capture the first environment image of the first video environment in a fixed location (e.g., position). For example, the first computing device may be attached to a tripod. The first computing device may be configured to capture the first environment image of the first video environment when attached to the tripod. The first environment image may comprise a photograph (e.g., optical photograph) or a video. The first environment image may comprise a depth image or a thermal image, or some combination of photo, video, depth image, and thermal image. The first environment image may be stereographic. Capturing the first video environment in a variety of ways, e.g., at different angles and/or in different spectra, may help to distinguish objects existing in first video environment. A user of the first computing device may be prompted to begin capturing the first environment image. The user of the first computing device may be prompted to end capturing the first environment image.

A holographic subject may be added into the first video environment. The holographic subject may not have been present when the first environment image of the first video environment was captured. The holographic subject may comprise one or more of a person, e.g., an actor, dancer, singer, speaker, etc., and/or a puppet or animatronic device. The holographic subject may be anything introduced into the scene which was not present the first environment image of the first video environment was captured. For example, the holographic subject may comprise a user associated with the computing device. The holographic subject may include more than one person and/or any props that the people carry, for instance.

At 604, a first video record may be captured. The first video record may be captured using the first computing device. The first computing device may be in the fixed position. The first video record may comprise a video of the holographic subject in the first video environment. For example, the first computing device may be configured to capture the first video record of the holographic subject moving in the first video environment. One or more video processing effects may be configured to be applied to the first video record. The one or more video processing effects may be configured to be applied to the first video record based on inputs received from a user of the first computing device. A user of the first computing device may be prompted to begin capturing the first video record. A user of the first computing device may be prompted to end capturing the first video record.

At 606, separation of a digital hologram of the holographic subject from any element of the first video environment visible in the first video record may be caused. The separation may be caused by sending the first environment image and the first video record to a second computing device located remote to the first computing device. The second computing device may receive the first environment image and the first video record from the first computing device. The second computing device may be configured to separate a digital hologram of the holographic subject from any element of the first video environment visible in the first video record. The second computing device may be configured to separate the digital hologram of the holographic subject from any element of the first video environment visible in the first video record using object detection.

The digital hologram may be integrated with (e.g., incorporated into) a second video environment to form a new video for display. For example, the digital hologram may be superimposable on a second video environment (e.g., new video environment) to create a second video record. For example, the digital hologram may be superimposed over a new static or moving 2D background video image or added to a 3D environment. The digital hologram may be positioned within the second video environment based on one or more inputs received from a user of the first computing device.

The second video environment may comprise any physical space and/or virtual environment. For example, the second video environment may comprise a pre-recorded, computer generated, and/or computer enhanced environment, or a combination of many environments. The second video environment may be captured by the first computing device. The second video environment may be captured by the first computing device while displaying a preview of the digital hologram superimposed on the second video environment. Alternatively, the second video environment may be captured by a different computing device, such as the third computing device. All of this may be facilitated by using object detection methods similar to those described by Lin, et al., without requiring the user to use a “green screen” to hide the environment in which the person is filmed.

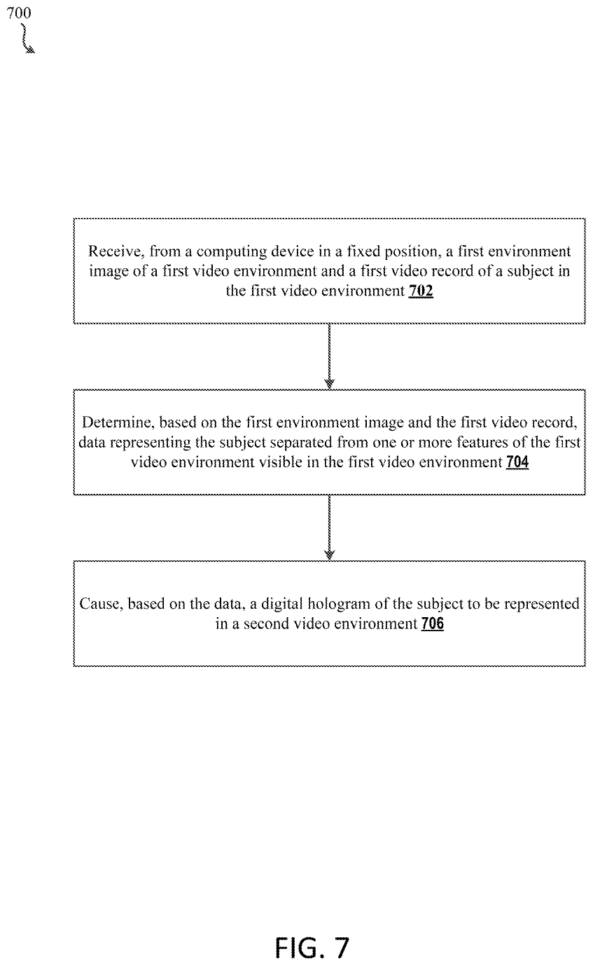

FIG. 7 illustrates an exemplary method 700 for method for automatic environment removal. The method 700 may be performed, for example, by the second computing device(s) 103 of FIG. 1.

At 702, a first environment image may be received. The first environment image may be captured using a first computing device. The first environment image may be received from the first computing device. The first environment image may comprise an image of a first video environment. The first computing device may comprise a camera. The camera may capture the first environment image of the first video environment. The first video environment may comprise a field of view of the camera. To capture the first environment image of the first video environment, a user of the first computing device may capture the first environment image in a room or in their home where no one is standing.

The first computing device may be configured to capture the first environment image of the first video environment in a fixed location (e.g., position). For example, the first computing device may be attached to a tripod. The first computing device may be configured to capture the first environment image of the first video environment when attached to the tripod. The first environment image may comprise a photograph (e.g., optical photograph) or a video. The first environment image may comprise a depth image or a thermal image, or some combination of photo, video, depth image, and thermal image. The first environment image may be stereographic. Capturing the first video environment in a variety of ways, e.g., at different angles and/or in different spectra, may help to distinguish objects existing in first video environment. A user of the first computing device may be prompted to begin capturing the first environment image. The user of the first computing device may be prompted to end capturing the first environment image.

A first video record may be received. The first video record may be captured using the first computing device. The first video record may be received from the first computing device. The first computing device may be in the fixed position. The first video record may comprise a video of a holographic subject in the first video environment. For example, the first computing device may be configured to capture the first video record of the holographic subject moving in the first video environment. One or more video processing effects may be configured to be applied to the first video record. The one or more video processing effects may be configured to be applied to the first video record based on inputs received from a user of the first computing device. A user of the first computing device may be prompted to begin capturing the first video record. A user of the first computing device may be prompted to end capturing the first video record.

The holographic subject may not have been present when the first environment image of the first video environment was captured. The holographic subject may comprise one or more of a person, e.g., an actor, dancer, singer, speaker, etc., and/or a puppet or animatronic device. The holographic subject may be anything introduced into the scene which was not present the first environment image of the first video environment was captured. For example, the holographic subject may comprise a user associated with the computing device. The holographic subject may include more than one person and/or any props that the people carry, for instance.

At 704, data may be determined. The data may be determined based on the first environment image and the first video record. The data may represent the holographic subject separated from one or more features of the first video environment visible in the first video environment. For example, the second computing device may be configured to separate a digital hologram of the holographic subject from any element of the first video environment visible in the first video record. The data may be determined using object detection.

At 706, a digital hologram of the subject may be caused to be represented in a second video environment. The digital hologram of the subject may be caused to be represented in a second video environment based on the data. Causing the digital hologram of the subject may be caused to be represented in a second video environment may comprise causing the digital hologram to be integrated with (e.g., incorporated into) a second video environment to form a new video for display. For example, the digital hologram may be superimposed on a second video environment (e.g., new video environment) to create a second video record. The digital hologram may be superimposed over a new static or moving 2D background video image or added to a 3D environment. The digital hologram may be positioned within the second video environment based on one or more inputs received from a user of the first computing device.

The second video environment may comprise any physical space and/or virtual environment. For example, the second video environment may comprise a pre-recorded, computer generated, and/or computer enhanced environment, or a combination of many environments. The second video environment may be captured by the first computing device. The second video environment may be captured by the first computing device while displaying a preview of the digital hologram superimposed on the second video environment. Alternatively, the second video environment may be captured by a different computing device, such as the third computing device. All of this may be facilitated by using object detection methods similar to those described by Lin, et al., without requiring the user to use a “green screen” to hide the environment in which the person is filmed.

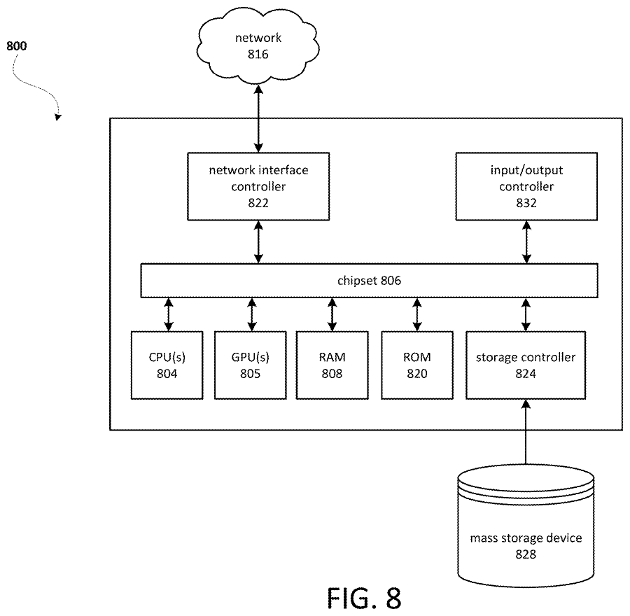

FIG. 8 depicts a computing device that may be used in various aspects. With regard to the example environment of FIG. 1, one or more of the first computing device 102, the second computing device(s) 103, the third computing device 104, the camera 106, the camera 108, and/or the separation model 108 may be implemented in an instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIG. 6, FIG. 7, and/or any other method described herein.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A user interface may be provided between the CPU(s) 804 and the remainder of the components and devices on the baseboard. The interface may be used to access a random access memory (RAM) 808 used as the main memory in the computing device 800. The interface may be used to access a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein. The user interface may be provided by a one or more electrical components such as the chipset 808.

The computing device 800 may operate in a networked environment using logical connections to remote computing nodes and computer systems through local area network (LAN) 818. The chipset 808 may include functionality for providing network connectivity through a network interface controller (NIC) 822, such as a gigabit Ethernet adapter. A NIC 822 may be capable of connecting the computing device 800 to other computing nodes over a network 818. It should be appreciated that multiple NICs 822 may be present in the computing device 800, connecting the computing device to other types of networks and remote computer systems.

The computing device 800 may be connected to a storage device 828 that provides non-volatile storage for the computer. The storage device 828 may store system programs, application programs, other program modules, and data, which have been described in greater detail herein. The storage device 828 may be connected to the computing device 800 through a storage controller 824 connected to the chipset 806. The storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 828 is characterized as primary or secondary storage and the like.

For example, the computing device 800 may store information to the storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the storage device 828 by detecting the physical states or characteristics of one or more particular locations within the physical storage units.

In addition or alternatively to the storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 828 may store other system or application programs and data utilized by the computing device 800.

The storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIG. 6 and FIG. 7 and/or any other method described herein.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
receiving, from a computing device in a fixed position, a first environment image of a first video environment and a first video record of a subject in the first video environment;
determining, based on the first environment image and the first video record, data representing the subject separated from one or more features of the first video environment visible in the first video environment; and
causing, based on the data, a digital hologram of the subject to be represented in a second video environment.

2. The method of claim 1, wherein determining, based on the first environment image and the first video record, data representing the subject separated from one or more features of the first video environment visible in the first video environment comprises determining the data representing the subject separated from one or more features of the first video environment visible in the first video environment using object analysis.

3. The method of claim 1, wherein causing, based on the data, the digital hologram of the subject to be represented in the second video environment comprises causing the digital hologram to be superimposed on the second video environment to create a second video record.

4. The method of claim 1, wherein the second video environment is captured by the computing device, and wherein causing, based on the data, the digital hologram of the subject to be represented in the second video environment comprises causing display, via the computing device, of a preview of the digital hologram on the second video environment.

5. The method of claim 1, wherein the computing device is a smart cell phone.

6. The method of claim 1, wherein the subject is at least one of a puppet, an animatronic robot, or one or more humans.

7. The method of claim 1, wherein causing, based on the data, the digital hologram of the subject to be represented in the second video environment comprises causing live streaming of a second video record associated with the second video environment while the first video record is being captured by the computing device.

8. The method of claim 1, wherein causing, based on the data, the digital hologram of the subject to be represented in the second video environment comprises causing positioning of the digital hologram within the second video environment based on one or more inputs received from a user.

9. A system comprising:
a computing device; and
a server located remote to the computing device, wherein the server is configured to:
receive, from a computing device in a fixed position, a first environment image of a first video environment and a first video record of a subject in the first video environment;
determine, based on the first environment image and the first video record, data representing the subject separated from one or more features of the first video environment visible in the first video environment; and
cause, based on the data, a digital hologram of the subject to be represented in a second video environment.

10. The system of claim 9, wherein the server is configured to determine, based on the first environment image and the first video record, the data representing the subject separated from one or more features of the first video environment visible in the first video environment using object analysis.

11. The system of claim 9, wherein the server is configured to cause, based on the data, the digital hologram of the subject to be represented in the second video environment by causing the digital hologram to be superimposed on the second video environment to create a second video record.

12. The system of claim 9, wherein the second video environment is captured by the computing device, and the server is configured to cause, based on the data, the digital hologram of the subject to be represented in the second video environment by causing display, via the computing device, of a preview of the digital hologram on the second video environment.

13. The system of claim 9, wherein the computing device is a smart cell phone.

14. The system of claim 9, wherein the subject is at least one of a puppet, an animatronic robot, or one or more humans.

15. A device comprising:
one or more processors; and
memory storing instructions that, when executed by the one or more processors, cause the device to:
receive, from a computing device in a fixed position, a first environment image of a first video environment and a first video record of a subject in the first video environment;
determine, based on the first environment image and the first video record, data representing the subject separated from one or more features of the first video environment visible in the first video environment; and
cause, based on the data, a digital hologram of the subject to be represented in a second video environment.

16. The device of claim 15, wherein the instructions that, when executed by the one or more processors, cause the device to determine, based on the first environment image and the first video record, the data representing the subject separated from one or more features of the first video environment visible in the first video environment comprise instructions that cause the device to determine, using object analysis, the data representing the subject separated from one or more features of the first video environment visible in the first video environment.

17. The device of claim 15, wherein the instructions that, when executed by the one or more processors, cause the device to cause, based on the data, the digital hologram of the subject to be represented in the second video environment comprise instructions that cause the device to cause the digital hologram to be superimposed on the second video environment to create a second video record.

18. The device of claim 15, wherein the second video environment is captured by the computing device, and wherein the instructions that, when executed by the one or more processors, cause the device to cause the digital hologram of the subject to be represented in the second video environment comprise instructions that cause the device to cause display, via the computing device, of a preview of the digital hologram on the second video environment.

19. The device of claim 15, wherein the computing device is a smart cell phone.

20. The device of claim 15, wherein the subject is at least one of a puppet, an animatronic robot, or one or more humans.
